(19) United States
(12) Patent Application Publication
(10) Pub. No.: US 2009/0271334 A1
(43) Pub. Date: Oct. 29, 2009

(54) SYSTEM AND METHOD FOR PROVIDING MORTALITY RATE INFORMATION AND EMPLOYING IT FOR STRUCTURING AND ANALYSIS OF FINANCIAL INSTRUMENTS

(76) Inventors: Alex Dubitsky, Larchmont, NY (US); Wendell Dave Dowrich, Norwalk, CT (US); Nigel Knowles, London (GB); Ethan Bronsnick, New York, NY (US)

Correspondence Address: BAKER BOTTS L.L.P., 30 ROCKEFELLER PLAZA, 44TH FLOOR, NEW YORK, NY, 10112-4498, US

(21) Appl. No.: 12/499,718

(22) Filed: Jul. 8, 2009

Related U.S. Application Data
(63) Continuation of application No. 11/195,233, filed on Aug. 2, 2005.

(51) Int. Cl. G06Q 40/00

(52) U.S. Cl. 705/36 R; 705/37

(57) ABSTRACT

The invention provides methods of extrapolating at least one future mortality rate by calculating a current year mortality rate for a particular age cohort, and applying a series of improvement factors to the current year mortality rate. The invention further provides methods of structuring a derivative financial instrument by providing projected going-forward mortality rates reflective of a degree of improvement in mortality rate experience for particular age cohorts for a particular future period, and defining settlement parameters wherein a value recognized by an investor in said instrument at the time of settlement relates at least in part to the correlation between said projected mortality rate and actually-incurred mortality rate for the age cohort during at least a portion of the period.

### BACKGROUND

The invention relates to a novel calculation, projection, estimation, and utilization of annual mortality rates for each discrete age of persons up to 100 years of age.

Known mortality rates are published by the Centers for Disease Control (“CDC”) and the United States Social Security Administration. Traditional CDC data discloses mortality rates for ten year age groupings (or on an individual age-year basis), for example ages 55-to-64 (or in some cases five year groupings). Although the CDC releases annual data, it is used to project mortality probabilities as opposed to mortality rates. The mortality probabilities have been traditionally used to assess how long people will live or to project financial liabilities that are mortality contingent. There exists a need to provide baseline mortality rates that can be used in conjunction with longevity products.

### SUMMARY OF THE INVENTION

It is an object of the present invention to release individual age mortality rates annually for each age or age cohort in a population grouping of interest, based upon what shall be referred to as “mortality rate” data. It is further an object of the present invention to show correlations of individual country mortality rates with the rates for other respective countries, for instance, a correlation of U.S. mortality rates with the mortality rates of the countries and regions of the world, for example the United Kingdom or the European Union. The annual mortality rates for each age and country or region of the world may be made available in a central location, which allows cross-boarder mortality experience analysis. The mortality rate information provided by the present invention also allows for extrapolation or projection of future mortality rates based on historical data and trend lines (both historic and anticipated, based on the finite and asymptotic improvement in lifespan and mortality rate that is possible over time). It is further an object of the present invention to distribute mortality rate information through computer-based systems (website, market data services, etc.), wherein the mortality rate information can be used as a more robust data source, as well as the underlying basis to establish mortality and longevity based swaps and other financial instruments and derivative instruments.

The mortality rate information provided by the present invention is a set of historical and projected mortality rates on general populations (or population subgroups, also known as age cohorts) for selected countries of interest. The mortality rate information serves as a source of common and consistent data to be used for structuring and settling transactions involving mortality and longevity risks within or between countries. The index is targeted for interested parties, such as insurance and reinsurance companies and mortality and longevity investors. It is a further object of the present invention to provide objective and transparent data regarding current mortality rates, anticipated changes in mortality rates for age cohorts of interest over time, and to allow improved analysis of variances among the mortality rates of discrete populations and age cohorts. The advantages of the present invention may be applied in structuring, evaluating, valuing, and trading financial instruments based directly or indirectly on one or more mortality rates or mortality rate projections that is of interest to one or more parties (or counterparties) to a mortality-rate based financial transaction.

### DETAILED DESCRIPTION

It is an object of the present invention to provide mortality data that may be used as a structuring tool, performance or analytic measure, or settlement or trade-price parameter, for mortality and longevity based derivative instruments that will settle based at least in part upon a life data index as described herein. This being so, the present invention provides the financial markets (and any other markets in which there is an interest in mortality rates, mortality or lifespan trends within or amongst particular populations, and related information) with a credible source of statistically-based discrete age mortality rates on an annual basis. In financial instrument markets, such information can be used, for example, for settling mortality and longevity based transactions. Further, the life data index data provided hereby can be used to derive life expectancies on certain aged individuals. The life expectancies can be used to make underwriting decisions on an individual or aggregate basis in making decisions in the life settlement and related markets, and in balancing, laying off, or hedging risk exposure in portfolios of life insurance policies and other mortality-dependent financial instruments.

The present invention has considerable use in embodiments for structuring, pricing, evaluating, valuing, trading, and settling derivative financial instruments. In a broad definition, derivative instruments may be understood as those in which an investor's realization or “payoff value” is “derived” from another value, probabilistic event, or combination of values and probabilistic events. Derivative instruments may be structured and traded on a party-counterparty basis (either in ad hoc transactions or through a marketplace), or on a party-to-marketmaker basis. Derivative instruments may be structured so as to directly reflect, hedge, or offset a particular probabilistic risk that a particular party has incurred or may incur. In conjunction with an embodiment of the present invention, such an “offset” derivative could be provided by structuring a financial product whose value would rise (or whose associated cash flows could hedge exposures) as the mortality rate rose unexpectedly, such that, for instance, a life insurer with large negative exposure to increased mortality rate in a particular age cohort could offset or hedge such risk by underwriting or assuming an appropriate dollar value of mortality-dependent contract or annuity, which would provide a hedge or profit for such insurer or investor when the annuity beneficiaries died “earlier” than expected.

More broadly, mortality-based derivative instruments may be structured without direct regard to any underlying death-related risk exposure apart from that incorporated into the structure of the instrument. For instance, in a basic embodiment, a party and counterparty could structure a mortality-based derivative instrument as essentially a wager over the parties' respective guesses as to mortality rates and trends in particular populations of interests—notably, though the mortality rate would play a role in the pricing and settlement of the derivative “wager,” neither party need have any real-life exposure (other than that provided by the derivative) to mortality based financial risk (in contrast to the life insurance example provided hereinabove).

In another exemplary embodiment of the present invention, the mortality rate information can be used to support longevity protection products. Baseline expectations of the level of future mortality can be set at the beginning of a trade, including a statement of future rates of improvement in mortality rates. A higher rate of future mortality improvement implies lower future expected mortality rates. A party may receive payment when the mortality improves relative to an original expectation. Likewise, a party may be required to make a payment when mortality worsens relative to an original expectation. Similarly, a party may be required to make a payment when mortality improves, and receive payment when mortality worsens.

For example, a life settlement is an existing life insurance policy that is purchased from the insured, wherein the value of the death benefits are expected to surpass the sum of the cost to purchase and maintain the life insurance policy, including any premiums. In accordance with an exemplary embodiment of the present invention, a set of discrete age mortality rates from published standardized tables are scaled such that they correspond with the aggregate experience exhibited by a group of such lives. The underlying data sources comprise the annually released CDC National Vital Statistics Report on “Deaths” and the U.S. Social Security Mortality Table data that is released every 10 years. The CDC age-range data is presented in 10-year age groupings, and is released annually showing the number of deaths per 100,000 in a given age grouping. The U.S. Social Security Mortality Table provides individual age mortality rates. The Census Year Age-range mortality rate is the CDC age-range data for a given age grouping from the latest Census year.

In an exemplary preferred embodiment of the present invention, the mortality rate information, or age Z mortality rate for year Y, for the ages ranging from 1-to-85 is calculated by multiplying the individual age Z mortality rate from the Census year Social Security mortality table by the ratio of the CDC age-range mortality rate for year Y to the CDC age-range mortality rate for the latest Census year. This calculation comprises: Age Z Mortality Rate from the census year Social Security mortality table for Year Y=Individual Age Z Mortality Rate from Census year mortality table x (CDC age-range mortality rate for year Y/CDC age-range mortality rate for latest Census year).

In an exemplary embodiment of the present invention, a mortality rate is imputed for each individual age within each of the ten year age groupings that are currently available. The mortality rate data for ages 1-100 will be shown historically to 1979 (and perhaps further back as far as 1900, if possible), and new mortality rates will be released annually for each age between ages 1-100. For example, the mortality rate of a person 55 years of age was 0.7% in 2002.

In an alternative embodiment, the single aged mortality rate for the ages ranging from 1-to-85 is the number of deaths for a given age divided by the number of people for that same age. This ratio, which reflects the full U.S. population, will generate a mortality rate for each within the range of ages 1-to-85 in a given year. (Analogous calculations could be carried out for other national or age-group populations of interest). This calculation assumes that the number of deaths per year and annual population data sources can be provided or closely estimated for the above-identified calculation. Up through age 85, the mortality rate is the ratio of reported deaths to the population estimated as of mid-year of the corresponding year. The reported deaths by age are adjusted to allocate the deaths reported with unknown age in proportion to all other deaths reported with age known. (such allocated deaths are relatively small—no more than 0.05% of all reported deaths in the US in any year between 1980 and 2002.). The calculation is expressed as follows:

Mortality Rate_{age,sex}=Adj Deaths_{age,sex}/(Mid Year Population_{age, sex}) Adj Deaths_{age, sex}=Deaths_{age,sex}+Deaths unknown_{age, sex}*(Deaths_{age,sex}/Total Deaths_{known ages,sex})

The mortality data for older aged individuals is less robust and therefore less credible. As a larger and larger proportion of individuals in age cohorts 85 years of age and higher become deceased, it becomes more difficult to track age at the time of death for the remaining (smaller) population. For this reason, it is an object of the present invention to provide an interpolation method to derive the mortality rates for individuals 86 years of age or older. the mortality rate is the result of linear interpolation between the mortality rate at age 85 actually experienced and the mortality rate at age 100 derived to minimize the least squares statistic described below. (Mortality rates for ages above 100 are not used in the Index.)

The derivation of the interpolated mortality rate for individuals 85 years old and over is expressed as follows:

M(x)=(Y^{λ}·Mᵣₐ)+((1−Y^{λ})·Mᵤₐ)

where Y=(ultimate age−x)/(ultimate age−reliable age)

and

M(x) is the interpolated mortality rate for age x

Mᵣₐ is the reliable age mortality rate

Mᵤₐ is the ultimate age mortality rate

λ is the curvature parameter

where ultimate age is the “outer bound age” of maximum expected longevity for any cohort member, and “reliable age” is the lower-bounding age for which cohort data is deemed statistically reliable.

In a preferred embodiment, the highest reliable range of years is 80 to 90 with a preferred age of 85, the arbitrary ultimate age is within the range 100-120, the curvature parameter (λ) is and the ultimate age mortality rate is within the range 0.8-1.2. The interpolated mortality rate can utilize a curvature parameter (λ) ranging from about 0.8-to-1.2, with the preferred value of approximately 1.0 given the nature of the projected mortality rates. The curvature parameter (λ) therefore can be modified to reflect the current nature of mortality rates.

In a preferred embodiment, the population base is the United States population corresponding to persons aged 1-to-100 years from 1980 to 2003 (and perhaps further back as far as 1900, given available data). Analogous data sets for other national, regional, or age-range population group can be used in related embodiments. The above described calculation can be released approximately 15 days after the annual CDC mortality statistics on various web sites, and through various news organizations and publications. The final result of the index history is the annual mortality rates for each discrete age up to age 100 for the years 1980-to-2002 (or for updated year ranges on a rolling basis going forward).

In an exemplary embodiment, the tabulation of deaths by individual age and sex appears in the CDC's Table 310, and corresponds to the total deaths in 2002 documented in National Vital Statistics Reports, Vol. 53, No. 5, Oct. 12, 2004 (“NVSR 53_{—}05”). The Technical Appendix of NVSR 53_{—}05 discusses the nature and sources of data used by the CDC.

As stated on page 102 of NVSR 5305 (which is the first page of the Technical Appendix), the CDC deaths (in our numerator) cover deaths in the U.S. of U.S. residents, as reported by state vital statistics registration offices (including those in Washington D.C. and the separate one in New York City), which then exclude all of the following: military and other government employees overseas; U.S. residents who die while traveling outside the U.S.; foreign residents who die while traveling in the U.S.; deaths in Puerto Rico, U.S. Virgin Islands, Guam, American Samoa and Northern Mariana Islands; deaths reported too late to be included in the tabulation (i.e., for 2002, deaths reported after Nov. 18, 2003 were excluded).

It is believed that more than 99 percent of deaths occurring in the U.S. are registered and therefore included in respective data from the CDC (as stated on page 23 of Technical Appendix of Vital Statistics of US 1999 Mortality). There is the possibility of some error in the correct age at death being reported for some people. The age reported is (notionally) the age at most recent birthday on or before the date of death.

In the exemplary embodiment, the denominator for the mortality rate is the Mid Year Population as of July 1. Mid year populations (as well as for the first of every month) are estimated by the Census Bureau for four alternative populations, where the alternatives deal with armed forces overseas and at home, and with institutionalized or non-institutionalized populations. To be consistent with the CDC data on deaths, we use the Census Bureau estimates for Resident Population (excluding Armed Forces Overseas, but including all residents, whether civilian or not, and whether institutionalized or not). From time to time the Census Bureau updates its prior estimates of population at prior July 1st, and if so, the present invention may use the most recent population estimate for July 1 of year N which is publicly available at the time the final CDC death counts for year N become available by individual ages (which may be 27 to 31 months after such July 1). For example, on Jun. 30, 2005 the Census Bureau released its latest estimate for the population on Jul. 1, 2004 and at the same time updated its estimated populations as of Jul. 1, 2000-2003 and other month ends. (Because 2004 was the year in which fell the last July 1 for which population was estimated in this series of estimates released on Jun. 30, 2005, this series of estimates is referred to as the 2004 Vintage. Earlier vintages, which may or may not include estimates by individual ages, are archived.)

The updated estimate for Jul. 1, 2003 published on Jun. 30, 2005 may well still be the most recent estimate of Jul. 1, 2003 population by individual ages by the date that 2003 final death counts by individual ages become available this Fall, so the invention may use these population counts as the denominators to calculate the mortality rates for the Mortality Index. Total males were 143,024,340 and total females were 147,764,636. For counts by individual age and sex, see http://www.census.gov/popest/national/asrh/files/NC-EST2004-ALLDATA-R-File08.txt accessed from http://www.census.gov/popest/national/asrh/2004_nat_res.html

The census bureau estimates of resident population is thought to have some net undercount, which may accumulate as the length of time since the last full census (in 2000, in 2010, . . . ) increases. However, the final mortality rates in year N, will use the best available denominators at the time of publication and there will be no “true up” in the Index for later estimates of population by the Census Bureau.

The census bureau estimates of population by age depend on age as reported in the prior census, adjusted for the passage of time, along with adjustments for changes in population. The age used in the July 1 estimate is the age as of the most recent birthday on or before that July 1. There are roughly offsetting differences between the populations by age X as of July 1 (year N) and the populations who could die sometime in year N and be age X at the date of death (but could be either age X−1 or age X+1 at July 1).

Appropriate deaths around the time of birth to be counted can be difficult to define, and the mid-year population at ago zero may have more incongruities with the deaths than is true for all other ages, so we would caution against using the mortality rate calculated at age zero. Currently, it is believed that results for age zero will not be used in the Mortality Index in any material way.

All population at or above age 100 are tabulated in one line. As a result, we only reference mortality rates through age 99. Using the numerators and denominators as described above, we calculate “raw” mortality rates for ages 86-99:

Raw Mortality Rate_{age,sex}=Adj Deaths_{age,sex}/(Mid Year Population_{age,sex})

This is the same process used for ages 85 and below, but—as described above—we develop a linear interpolation substitute (Mortality Rate age, sex) that interpolates mortality rates for ages 86 to 100 for a given sex in the given calendar year. The age 100 mortality rate is derived to minimize the least squares statistic (“LSS”) defined as follows (for the given sex in the given calendar year):

LSS=sum over ages 86 through 99 of (Mid-Year Population_{age,sex}) times the square of (Mortality Rate_{age,sex} minus Raw Mortality Rate_{age,sex})

We have calculated mortality rates for prior years, starting with 1980, with essentially the same method as used for the ongoing “most recent year.” We say “essentially the same” because our denominators use census estimates available today for the July 1 dates in 1980 through 2001, and these estimates have some benefit of hindsight not always available within two to three years after a given July 1. In particular, all of our population estimates for 1980-1999 take advantage of knowing census results both before and after the given year (and are therefore “intercensus estimates”).

In preparation for projecting mortality rates, we derive the average annual historical rate of improvement in mortality rates between the most recent year (the “Current Year”) and the year ten years before the Current Year for each individual age and sex. Specifically, using population estimates by age from the most recent year to weight the observed mortality rates by age for both the start and end of a ten year observation period (or 20 year, as appropriate), we develop average annual mortality improvement factors for central ages within five year age groups (and each sex) and interpolate between such central ages to derive average annual mortality improvement factors for each other age (and each sex). The central ages are 3, 8, 13, 18, 23, . . . , 68, 73, 78, 83, 88, 93, and 98 for the five year age groups 1-5, 6-10, 11-15, 16-20, 21-25, . . . , 66-70, 71-15, 76-80, 81-85, 86-90, 91-95, and 96-100, respectively.

For ages through 85, we start with the average annual rate of improvement over the prior 10 years. However, because of the smaller sample sizes associated with the older ages, we measure the annual average rate improvement over the prior 20 years.

An example of the calculation of a historical improvement factor between 1992 and 2002 for a female at an age such as 80 would start with the two five year groups 76-80 and 81-85. Using the female population by individual ages 76-85 in 2002, average death rates for 1992 and 2002 for central (average) ages 78 and 83 would first be calculated using formulas such as the following:
Avg. Mortality Rate_{age 78, female, 1992}
   =Population_{age76, female, 2002}* Mortality Rate_{age 76, female, 1992}
   +Population_{age77, female, 2002}* Mortality Rate_{age 77, female, 1992}
   +Population_{age78, female, 2002}* Mortality Rate_{age 78, female, 1992}
   +Population_{age79, female, 2002}* Mortality Rate_{age 79, female, 1992}
   +Population_{age80, female, 2002}* Mortality Rate_{age 80, female, 1992}
   Divided by: Total Population_{age76-80, female, 2002}

In order to ensure comparability, we weight the mortality rates within each bracket by the 2002 age-specific Population for both the 1992 and 2002 sets of statistics.

The average annual improvement for both ages 78 and 83 would be derived by taking one minus the tenth root of the ratio of the Average Mortality Rates ten years apart. For age 78 this ratio is Avg. Mortality Rate_{age 78, female, 2002}/Avg. Mortality Rate_{age 78, female, 1992}.

The Avg. Mortality Rate is assigned to the midpoint of the age bracket. For example, the computed rate for the 76-80 bracket is assigned to age 78. In that manner annual improvement factors are determined for ages 3, 8, 13, . . . , 93, 98). We compute improvement factors for age 0 with no bracketing. For all other ages, we use linear interpolation (extrapolation for 99 and 100) to determine the improvement factor. For example, the improvement factor for age 97 males=_{if 97, m, 2002}=20%×_{if 93, m, 2002}+80%×_{if 98, m, 2002}.

The historic improvement factors computed above are then limited to be not less than −2% nor more than 2%. For future years, the Improvement Factors (IFs) are based on the limited historic improvement factors with the following credibility adjustments: For the first 10 years, 100% of these factors are used, followed by a linearly decreasing set of credibility factors grading from 100% in the 10th year to 0% in the 30th year, i.e., over 20 years. Thereafter, the Improvement Factors are fixed at 0%.

The mortality rate information also extrapolates future mortality rates based on historical data and trend lines. Thus, another embodiment of the present invention can provide the market with a baseline expectation of mortality rates on a projected year-to-year rolling going-forward basis (for age and population cohorts of interest) so that interested parties can form a view of mortality in anticipation of entering into longevity product investments or transactions, such as, for example, mortality swap transactions. Mortality rate projections may calculated for each particular age until that particular age reaches 100 (or other age of interest). For example, a person aged 50 years (or the entire cohort of 50 year old persons for a given calendar year) could be assigned 50 years of projections such that a deemed mortality rate could be calculated for each calendar year as that person or cohort ages towards 100. A person aged 51 years old could be assigned 49 years of projections, and so on.

The mortality rate projections may be calculated in the present invention using recalculated historical improvement factors (relating to the 10 year period, or 20 year period as appropriate, ending in the most recent year, with such calculations capable of being performed each time (or each increment of times) a new set of mortality rates are calculated or supplied for the most recent year in which data becomes available. Mortality rates may be projected for the remaining lifetime of all current lives. Projections show how the most recent mortality rates at age X will have improved by the time a “life” (i.e., an individual or an age cohort) has attained age X in year N.

The mortality rate at a given age X in year N, known as the mortality rate projection, is derived from a series of improvement factors that are assumed for the sex and age of a person (cohort) of age X, which is applied to the derived mortality rate for a person (cohort) of age X in the most recent year. The projected mortality rate may be calculated, in an exemplary and preferred embodiment, as follows:

M(x)_{g,N}=M(x)_{g, current year}·(1−IF(x)_{g, current year+1})·(1−IF(x)_{g, current year+2})· . . . ·(1−IF(x)_{g, N}) M(x)=M(x)_{g, current year}·Π(1−IF(x)_{g, n}), where n=current year+1, N

where,

M(x) g, N is the projected mortality rate for a life (or cohort) of age x in year N of gender g.

g is the gender (male or female) of the life/cohort.

x is the age of the life/cohort.

N is the year in which a life attains age x (N=most recent year+(x−age in most recent year)).

IF is an Improvement Factor

The Improvement Factor for a given year relates to the mortality rate for the given year to the mortality rate of the current year. There is no assumption that different cohorts within a given age cohort have different rates of improvement. The rates of improvement depend on a particular age X, through which every cohort within a given age and younger than age X will move at some future date.

The Improvement Factors are the historical average improvement factors for the particular age X of gender g, and, in a preferred embodiment, are limited to the range of −5.0%-to 5.0%, allowing for credibility adjustments. In a preferred embodiment, the credibility adjustments are as follows: For the first ten to 30 years, substantially 100% of the limited historical Improvement Factors are used; a linearly decreasing set of credibility factors is then applied for a subsequent 15-30 year period, grading downward from substantially 100% in the tenth year to substantially 0% of the limited historical Improvement Factors in the final year. Thereafter, the Improvement Factors are fixed at 0% of the limited historical Improvement Factors.

It is further an object of the present invention to show correlations, known as index correlations, of the individual national, regional, or age cohort mortality rates with the mortality rates of other respective age cohorts, nations, and regions of the world. The present invention provides historical and projected mortality rates for multiple regional and age cohort groupings that may be of interest. Correlation analysis is performed on the absolute mortality rates between different sub-groups (based on age cohort, sex, region, nation), and on the rates of change in mortality rates of different sub-groups. Interested parties, such as for example insurance and reinsurance companies and mortality and longevity investors, can assess the value in longevity based protection products.

For example, an insurance company may have UK population based longevity risk, and may want to enter into a U.S. population based longevity swap to hedge their UK longevity risk. The index correlation allows an insurer to assess the impact of a U.S. based trade relative to its UK risk—the basis risk in hedging one population, such as the UK, with another population, such as the U.S.

The sources of the base data on which the mortality rates may be calculated include the following: 1). US Dept of Health and Human Services: Centers for Disease Control and Prevention (CDC): Table 310: Deaths by Single Years of Age, Race and Sex, United States—example link http://www.cdc.gov/nchs/data/dvs/MortFinal2002_Work310.pdf; and 2). US Census National Population Estimates, Monthly Postcensal Resident Population, by single year of age, sex, race, and Hispanic Origin—example link http://www.census.gov/popest/national/arsh/2004_nat_res.html. Of course, other reliable death-rate, lifespan, and mortality-related data, projections, or estimates for respective groups or sub-groups of population that are of interest may also be advantageously used as input for mortality rate indices and derived applications and products based thereupon.

Those of ordinary skill in the art will appreciate that the foregoing discussion of certain embodiments and preferred embodiments is illustrative only, and does not limit the spirit and scope of the present invention, which is limited only by the claims set forth below.

1-10. (canceled)

11. A method of facilitating trading of derivative financial instruments, comprising:
utilizing calculated mortality rate information for at least one of: (a) pricing; (b) evaluating; (c) trading; or (d) settling a trade in a derivative financial instrument whose financial traits are dependent at least in part upon at least one mortality rate.

12-19. (canceled)

20. A method of facilitating trading of financial instruments, comprising:
utilizing calculated mortality rate information for at least one of: (a) pricing; (b) evaluating; (c) trading; or (d) settling a trade in a financial instrument.

21. The method of claim 20, wherein the calculated mortality rate involves calculating a current year mortality rate for a particular age cohort and applying a series of improvement factors to the current year mortality rate.

22. The method of claim 20, wherein said series of improvement factors includes an improvement factor for each subsequent year between a projected year and the current year.

23. The method of claim 22, wherein said improvement factor for each subsequent year between the projected year and the current year relates the mortality rate for each respective year to the current year mortality rate.

24. The method of claim 23, wherein said improvement factors for at least some subsequent years before the projected year are respectively each between 31 2% and 2%.

25. The method of claim 24, wherein said improvement factors for at least some subsequent years before the projected year are adjusted by a credibility adjustment for each year.

26. The method of claim 25, wherein said credibility adjustment for at least a defined sub-period of subsequent years is linearly graded from 100% to 0%.

27. A financial processing system, including a processor and memory, for facilitating trading of financial instruments, the processor configured to execute one or more instructions for carrying out the steps comprising:
utilizing calculated mortality rate information for at least one of: (a) pricing; (b) evaluating; (c) trading; or (d) settling a trade in a financial instrument.

28. A computer readable medium including one or more instructions for facilitating trading of financial instruments, the instructions configured to cause a computer processor to carry out the steps comprising:
utilizing calculated mortality rate information for at least one of: (a) pricing; (b) evaluating; (c) trading; or (d) settling a trade in a financial instrument.
